(19) United States
(12) Patent Application Publication
(10) Pub. No.: US 2013/0263045 A1
(43) Pub. Date: Oct. 3, 2013

(54) SCREEN DISPLAY DEVICE AND SCREEN DISPLAY SYSTEM

(71) Applicant: KABUSHIKI KAISHA TOSHIBA, Tokyo (JP)

(72) Inventors: Mika Minematsu, Tokyo (JP); Masataka Goto, Kanagawa (JP); Takuya Kawamura, Kanagawa (JP); Makoto Takahashi, Saitama (JP)

(73) Assignee: Kabushiki Kaisha Toshiba, Tokyo (JP)

(21) Appl. No.: 13/776,621

(22) Filed: Feb. 25, 2013

(30) Foreign Application Priority Data
Mar. 29, 2012 (JP) 2012-078368

(51) Int. Cl. G06F 3/0481

(52) U.S. Cl. CPC G06F 3/0481
USPC 715/788

(57) ABSTRACT

A screen display device specific display areas controlled by operation of a layout control terminal and is connected to the layout control terminal via a network. The screen display device is equipped with a window composition information generation section that generates screen composition information of the specific display areas in accordance with the operation of the layout control terminal, a layout management section that manages the screen composition information of the specified area, and a communications section that sends the screen composition information of the specific display areas to the layout control terminal.

### CROSS-REFERENCE TO RELATED APPLICATION

This application is based upon and claims the benefit of priority from Japanese Patent Application No. 2012-078368, filed Mar. 29, 2012; the entire contents of which are incorporated herein by reference.

### FIELD

Embodiments described herein relate to a screen display device and a screen display system.

### BACKGROUND

A cooperative working system streamlines information sharing and collaborative work by displaying necessary information on a large screen display device and on operating terminals that are connected to the large screen display device via a network. On the large screen display device, it is possible to simultaneously display plural windows, and, through the operation of the users, it is possible to move, resize, delete, and otherwise manipulate, each window.

In order for the user to manipulate the screen layout on the large screen display device from a layout control device, an existing screen transferring system maybe employed. With a screen transferring system, a display device that possesses a simple input-output interface is operated on the user-side, and complex arithmetic processing is conducted on a server device that is operated at a remote location. The server device responds to inputs made at the display device, draws the screen information, and sends the screen information for the updated areas to the display device.

### DESCRIPTION OF THE DRAWINGS

FIG. 1 is a diagram showing an example of a large screen display device according to a first embodiment.

FIG. 2 is a diagram that shows an example of window composition information of the first embodiment.

FIG. 3 is a flowchart that shows an overview of a window operation process according to the first embodiment.

FIG. 4 is a flowchart that shows an overview of a window composition information transmission process according to the first embodiment.

FIG. 5 is a flowchart that shows an overview of a window image transmission process according to the first embodiment.

FIG. 6 is a diagram that shows an example of a displayed screen in the first embodiment.

FIG. 7 is a diagram that shows an example of a window that is deemed necessary to update in the first embodiment.

FIG. 8 is a diagram that shows an example of a large screen display device according to a second embodiment.

FIG. 9 is a flowchart that shows an overview of a window composition information transmission process of the second embodiment.

FIG. 10 is a diagram that shows an example of a large screen display device according to a third embodiment.

FIG. 11 is a diagram that shows an example of a displayed screen in the third embodiment.

FIG. 12 is a diagram that shows an example of a large screen display device according to a fourth embodiment.

FIG. 13 is a diagram that shows an example of a displayed screen in the fourth embodiment.

FIG. 14 is a diagram that shows an example of a large screen display device according to a fifth embodiment.

FIG. 15 is a flowchart that shows an overview of a window composition information transmission process of the fifth embodiment.

FIG. 16 is a diagram that shows an example of a window deemed necessary to update in the fifth embodiment.

### DETAILED DESCRIPTION

A screen transferring system detects updated areas of an entire screen and sends a compressed image of the updated areas periodically. During these updates, acquisition processes, compression processes, and network transfer processes all occur, and so there is a problem, especially with large screens, that the processing and transfer load put on the screen transferring system will be high.

The problem that this invention solves is to provide a screen display device and a screen display system that alleviates (reduces) the processing and transfer load on the system when screen information changes or is updated.

In order to achieve the above objective, the screen display device allows control of specific areas of the displayed screen through operation of a layout control terminal, which is connected to the display device via a network. The screen display device is equipped with a window composition information generation section that generates screen composition information for the specific areas targeted by operations of the layout control terminal, a layout management section that manages the screen composition information for the specific areas, and a communications section that sends the screen composition information for the specific areas to the layout control terminal.

Also disclosed is a screen display system equipped with a layout control terminal and a display device that connects to the layout control terminal via a network. The screen display device is equipped with a window composition information generation section that generates screen composition information for the specific areas that correspond to the operation of the layout control terminal, a layout management section that manages the screen composition information for the specific areas, and a communications section that sends the screen composition information for the specific areas to the layout control terminal.

### First Embodiment

A screen controlling device according to a first embodiment is explained by referencing the figures. An example of a large screen display device 100 according to a first embodiment is described.

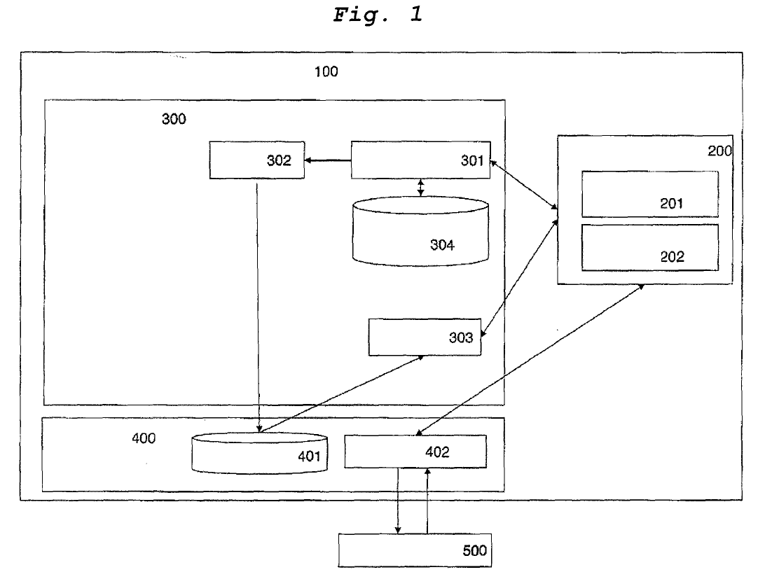

As shown in FIG. 1, the large screen display device 100 according to the first embodiment is equipped with a web server program 200, a window server 300, and hardware 400. The web server program 200 is equipped with a window composition information generation section 201 (“generation section 201”) and a window operating instructions issuing section 202 (“issuing section 202”).

The generation section 201 generates screen composition information for specific areas on the large screen display device 100. The screen composition information of specific areas can be of any format, as long as it can be used to discern the screen layout of the large screen display device 100. For example, to distinguish windows, generation section 201 can generate the layout information of the window, a window image, or a window list that includes window names. For a window list, the list can include all windows, or it can include only the windows where the parent window is the root window. A root window is a window that represents the entire screen.

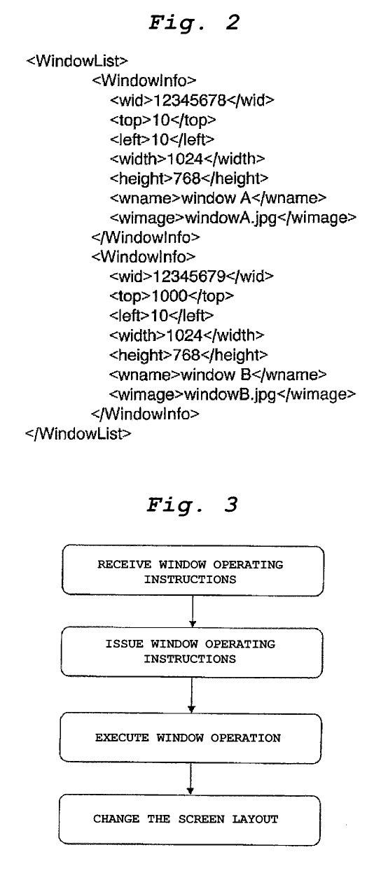

An example of a window list is shown in FIG. 2. In FIG. 2, the example list includes a window identifier, the x-coordinates and y-coordinates of the display position, width, height, name, and image.

The specific areas of the large screen display device 100 can be denoted as specific windows. In the case of, for example, sending a window list as window composition information (that is, screen composition information), to the layout control device 500, the layout control device 500 will generate and display screen information in accordance with the window composition information.

Also, it can generate screen information that should be displayed on the layout control device 500. In this case, on the layout control device 500, the window composition information that it receives is displayed as is.

The layout control device 500, for example, when it receives window composition information shown in FIG. 2, will display windowA.jpg with a width of 1024 pixels and height of 768 pixels on the layout control device 500 from the (10, 10) position on its screen, and display windowB.jpg with a width of 1024 pixels and a height of 768 pixels from the (10, 1000) position on the screen.

The layout control device 500 is a terminal that the user operates, and when the user operates/manipulates the screen of the layout control device 500 (layout control terminal), it will issue a window operation command that corresponds to the operation of the web server program 200 on the large screen display device 100. For example, if one clicks the (100, 100) location (a screen area within where Window A is displayed) on layout control device 500 and move that screen area to (200, 100), it will issue a window move command to move Window A 100 pixels to the right.

The issuing section 202 receives the window operation instructions from the layout control device 500 and issues the window operating instructions to the layout management section 301.

Meanwhile, the web client program on the layout control device 500 and the web server program 200 on the large screen display device 100 can be implemented as a CGI (common gateway interface) module that receives requests from the browser module (index.html) and the browser and approaches the window server 300. The two will communicate with the HTTP protocol, and the CGI module will function only when it receives a request from the browser.

The window server 300 is equipped with a layout management section 301, a drawing section 302, an image acquisition section 303, and a layout information storage section 304.

The layout management section 301 manages the layout information of the windows that are displayed on the large screen display device 100.The layout information is stored in memory in the layout information storage section 304. The layout management section 301 receives window operating instructions from the issuing section 202, and, in order to change the screen layout according to the window operating instructions, updates the layout information, and issues drawing instructions to the drawing section 302. Layout information includes the window identifier, display position, size, and overlap area information.

Meanwhile, the display position will be stored using coordinate information, etc. Coordinate information is information that is expressed using a coordinate system that will, for example, in a screen that is 1024×768 pixels, make the upper left of the screen (0, 0) and the lower right of the screen (1023, 767). The storage method can be anything as long as the method of window positioning can be understood. If the window server 300 is for example X-server, it can acquire window attributes such as the window identifier, display position, size, using the XGetWindow Attributes function. The XqueryTree function can be used to obtain the parent window and a list of sub-windows (children) for a given window

The drawing section 302 receives drawing instructions from the layout management section 301 and, according to the drawing instructions, will draw the screen information resulting from various screen processes conducted in the frame buffer 401.

The image acquisition section 303 acquires the window image from the frame buffer 401 (see below). For example, in the case of an X-server, it can acquire the window image using the XGetImage function.

Meanwhile, the image acquisition section 303 can include compression processes and shrinking (scaling) processes. Compression processes compress window images. Shrinking processes shrink the window images.

The hardware 400 is equipped with a frame buffer 401 and a communications section 402.

The frame buffer 401 is a storage section that stores screen information displayed in the large screen display device 100. The frame buffer 401 may be configured as any type of storage medium such as, for example, a Random Access Memory (RAM), a Hard Disk Drive (HDD), an optical disk, or a memory card.

The communications section 402 conducts communication with the layout control device 500.

Next, the window operating process and the window composition information transmission process by the large screen display device 100 which pertains to the first embodiment will be described.

To start, a brief overview of the window operating process depicted in FIG. 3 will be provided. First, the issuing section 202 receives window operating instructions from the layout control device 500 via communications section 402. The window operating instructing can include, for example, window moving instructions and resizing instructions. These instructions can be formed by issuing a Move request and a Resize request from the browser to the web server using the GET method in HTTP, for example.

Next, the issuing section 202 issues window operating instructions to the layout management section 301. For example, in the case of X-server, it will issue XMoveWindow functions and XResizeWindow functions.

Next, the layout management section 301 will update the layout information (stored in layout information storage section 304) according to the window operating instructions and issue drawing instructions to the drawing section 302. The drawing section 302 then draws in the frame buffer 401, and the screen layout of the large screen display device 100 will be changed.

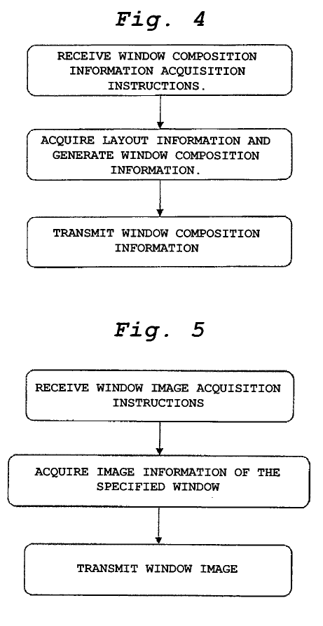

Now a brief overview of the window composition information transmission process will be provided using FIG. 4. First, the generation section 201 receives the window composition information acquisition instructions from the layout control device 500 (via communications section 402). Next, the generation section 201 acquires layout information from the layout management section 301 and generates window composition information.

Next, the generation section 201 sends the window composition information to communications section 402 to transmit to the layout control device 500.

Now, a brief overview of the window image transmission process will be provided using FIG. 5. First, the generation section 201 receives the window image acquisition instruction from the layout control device 500. Next, the generation section 201 acquires the window image from the image acquisition section 303.

Then, the generation section 201 sends the window image to the communications section 402 to transmit to the layout control device 500.

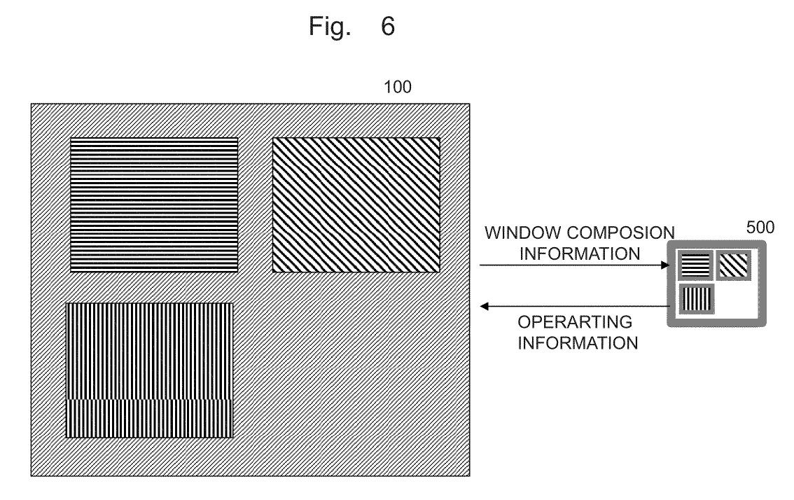

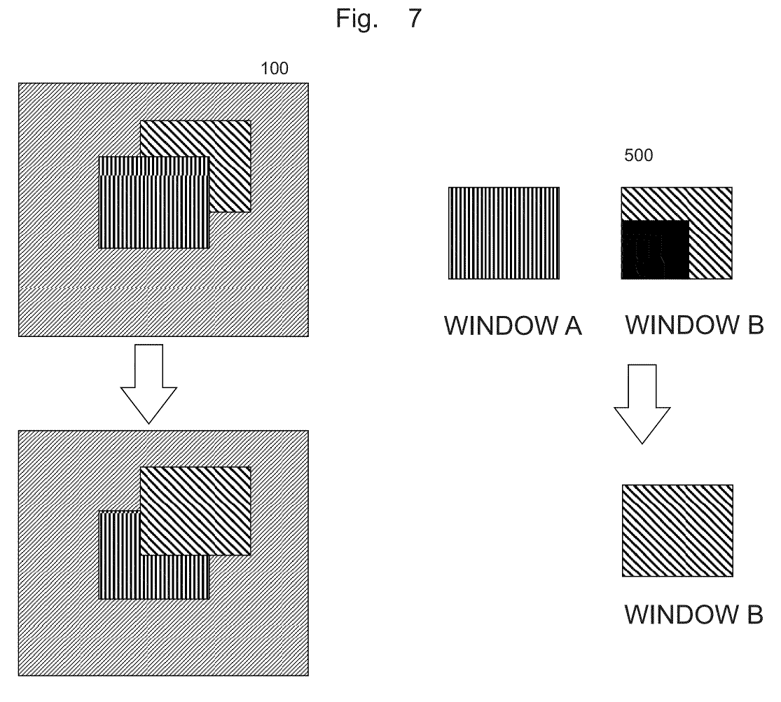

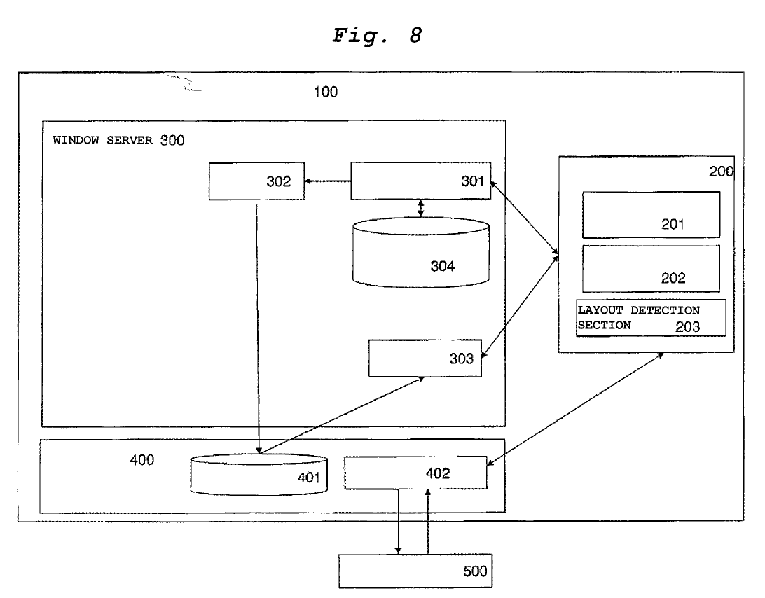

FIG. 6 is an example of a displayed screen at the layout control device 500. The update processing and network transfer load can be alleviated by acquiring just the window image and not the entire screen image.

Also, with the layout control device 500, layout information is acquired periodically. On these occasions, for example, newly displayed windows are detected, as are windows that were moved to the front and the parts that were hidden but now are displayed. For example, a window with a new window identifier is deemed a newly displayed window, and a window that has a smaller overlapping area can be determined to be a window that had its hidden parts displayed.

An example of a detected window is shown in FIG. 7. As shown in the figure, in general, when acquiring a window image, areas that are not to be displayed on the screen for whatever reasons, such as being hidden by other windows, will be acquired as black images. For this reason, by reacquiring the window image of the window that had its hidden parts displayed, the black parts are updated and the updated information can be displayed.

The process to detect windows that should be updated can be done in the large screen display device 100, the layout control device 500, or on a server that is otherwise separately set up. In the case that when the detection process is done on the large screen display device 100, when it receives the window image acquisition instruction, it will acquire only the window image of the detected window and transmit only this window image. The large screen display device 100 can transmit the window image and at the same time receive the window composition information acquisition instruction without distinguishing the window composition information acquisition instruction from the window image acquisition instruction.

On the other hand, in the case when the detection process is done on the layout control device 500 or the server device, the layout control device 500 or the server will receive the window image acquisition instruction of the specified window and will acquire the window image of only the specified window and transmit it.

In this way, the large screen display device according to the first embodiment can alleviate the processing and transfer load by transmitting not the entire screen but just the updated window image. Also, the load can be alleviated by not transmitting constantly, but just transmitting a window image of the window that includes the updated area only when the window is newly displayed on the screen.

### Second Embodiment

In the first embodiment, the window composition information is updated by using a periodic window composition information acquisition instruction sent from the layout control device 500 as a trigger.

In the second embodiment, an example will be explained, in which the window composition information update is triggered when a change of layout is detected by the large screen display device 100.

In FIG. 8, a block diagram of the large screen display device 100 of the second embodiment is depicted.

The second embodiment includes a layout change detection section 203 (“detection section 203”). The issuing section 202 and the generation section 201 have somewhat different functions than in the first embodiment. The other components are the same as the large screen display device 100 according to the first embodiment, so their descriptions may be omitted. The same legend numbers for the sections that are common with the first embodiment are used.

The detection section 203 detects windows that have had their hidden parts displayed, and then notifies the generation section 201 when a change is detected. For example, in the case of an X-server, detection section 203 can receive pertinent information about a window when the window's hidden part is displayed, by specifying an ExposureMask with the XSelectInput function.

The issuing section 202 will notify the generation section 201 of the identity of the layout control device 500 that issued the window operating instructions.

The generation section 201 will then acquire from the image acquisition section 303 the window image of the window for which a notification from the detection section 203 was received and generate window composition information accordingly.

Also, when there are plural layout control devices 500, when the generation section 201 receives notification from the issuing section 202, it will acquire layout information from the layout management section 301 and will generate window composition information for all the other layout control devices 500 other than the layout control device 500 that issued the window operating instructions.

With this, when there are plural users conducting window operations from plural layout control devices 500, it is possible to reflect the changes in the screen layout made by window operations conducted by other users onto the layout control device 500. When differing operating instructions from plural users to the same window are received at approximately the same time, the last to arrive operating instruction, for example, will be executed.

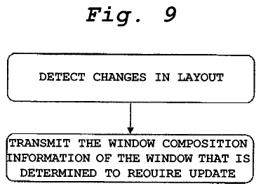

Next, the window composition information transmission process depicted in FIG. 9 for the large screen display device 100 related to the second embodiment is described. Regarding the window operating process, it is the same as the function of the large screen display device 100 related to the first embodiment.

In the first embodiment, the layout information and the window images are transmitted as window composition information using the request from the layout control device as the trigger. In the second embodiment, window composition information is transmitted with the detection of a layout change in the large screen display device 100 as the trigger.

First, the generation section 201 receives notification from the detection section 203 regarding a window that had its hidden area displayed. The detection section 203 then acquires the window image of the pertinent window from the image acquisition section 303 and generates window composition information for all the layout control devices 500.

The generation section 201 also receives notification of the layout control device 500 that issued the window operation from the issuing section 202, acquires layout information from the layout management section 301, and generates window composition information for all the other layout control devices 500 that are not the layout control device 500 that issued the window operation. Then, the communications section 402 will transmit the window composition information to all the other layout control devices 500 that are not the layout control device 500 that issued the window operation.

HTTP protocol is a type of protocol that responds to requests, and as long as there is no request from the browser, the web server will not send a response. Thus, to implement two-way communications between a web server and browser, a communications standard called WebSocket has been developed. With WebSocket, the web server and the browser will handshake (conforming to HTTP standards), and then the browser will send a request to the web server to upgrade/switch to WebSocket protocol. The HTTP connection that used for the handshake can then be used for data sending/receiving as a WebSocket connection. The second embodiment can be realized using WebSocket.

In this way, with the large screen display of the second embodiment, it is possible to alleviate the processing and transmission load by transmitting only to the layout control device 500 that needs to transmit window composition information of the window that is determined as needing to be updated, using the detection of a layout change as the trigger.

### Third Embodiment

With the first embodiment, the window image was included in the window composition information. With the third embodiment, the window name is included in the window composition information.

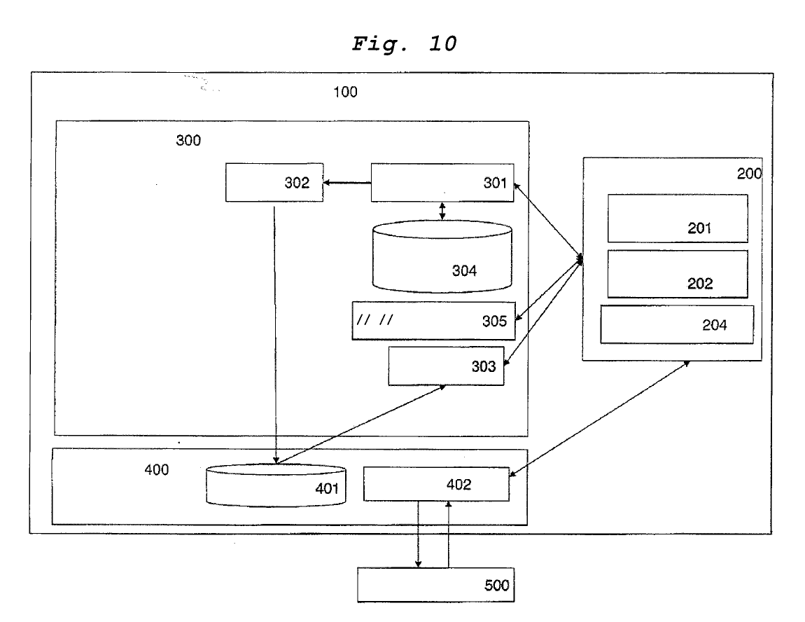

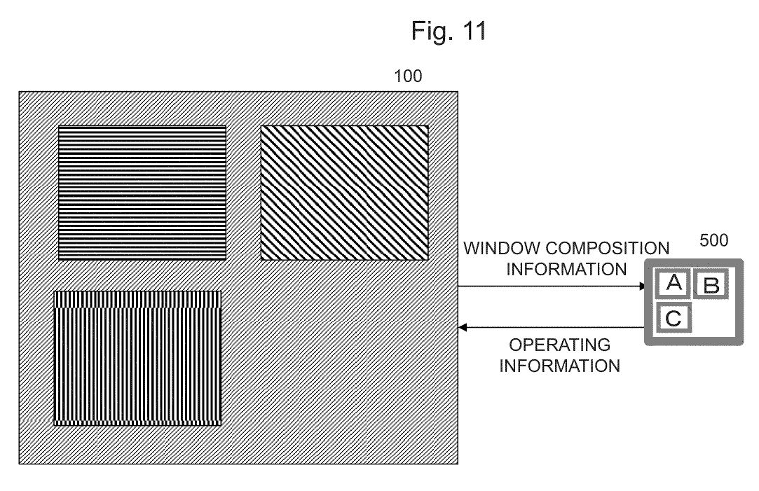

A block diagram of the large screen display device according to the third embodiment is shown in FIG. 10. Also, FIG. 11 is an example of a displayed screen in a layout control device 500 according to the third embodiment.

The third embodiment differs from the first embodiment in the inclusion of a load acquisition section 204 and a window name acquisition section 305. The generation section 201 in the third embodiment differs somewhat in function from the first embodiment. The other components are generally the same as and function similarly to the large screen display device 100 according to the first embodiment, and their descriptions are omitted here. Regarding the sections that are common with the first embodiment, same legend numbers are used.

The load acquisition section 204 acquires a load metric (a measure of resource utilization) at the layout control device 500. The window name acquisition section 305 acquires the window name.

The generation section 201 acquires the window name from the window name acquisition section 305 when the load metric at the layout control device 500 is higher than some threshold value t and includes the window name in the window composition information rather than the window image.

A window name can be, for example, set as the title of the window. For example with X-server, a name can be set and acquired with the XSetWMName function and the XGetWMName function, respectively.

Meanwhile, plural threshold values can be set for the load metric at the layout control device 500, and window images with higher compression rates and shrinking rates can be included in the window composition information when the load of the layout control device 500 is higher than some threshold value t1 but lower than some threshold value t2. The window name can be included in the window composition information when the load metric of the layout control device 500 is higher than threshold value t2.

The window name can also be included in the window composition information (instead of the window image) when the load of the large screen display device 100 is high and not just when the load of the layout control device 500 is high.

In this way, with the large screen display device according to the third embodiment, it is possible to alleviate the processing and transfer loads while maintaining the discernibility of the window by sending the window name and not the window image when the load of the layout control device 500 is high.

### Fourth Embodiment

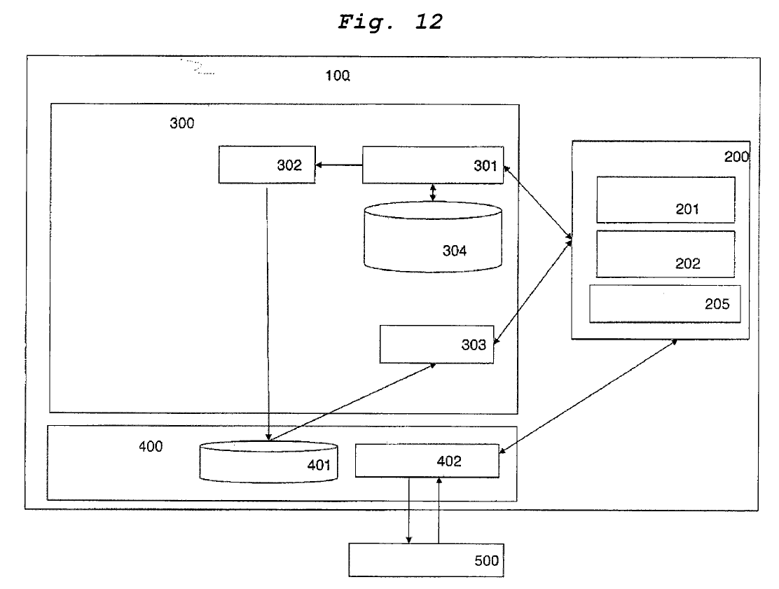

With the first embodiment, the window composition information of the entire screen on the large screen display device 100 is transmitted. In the fourth embodiment, an example where only the window composition information of the window that is displayed on the layout control device 500 is transmitted is described. A block diagram of the large screen display device 100 according to the fourth embodiment is shown in FIG. 12.

In the fourth embodiment, a display area acquisition section 205 is included in web server 200, and the generation section 201 has a somewhat different function than in the first embodiment. The other components are generally the same as the large screen display device 100 according to the first embodiment, so their descriptions are omitted here. Regarding the sections that are common to the first embodiment, the same legend numbers are used.

The display area acquisition section 205 acquires the display area that is displayed on the layout control device 500. The generation section 201 generates only the window composition information of the window that is displayed in the display area.

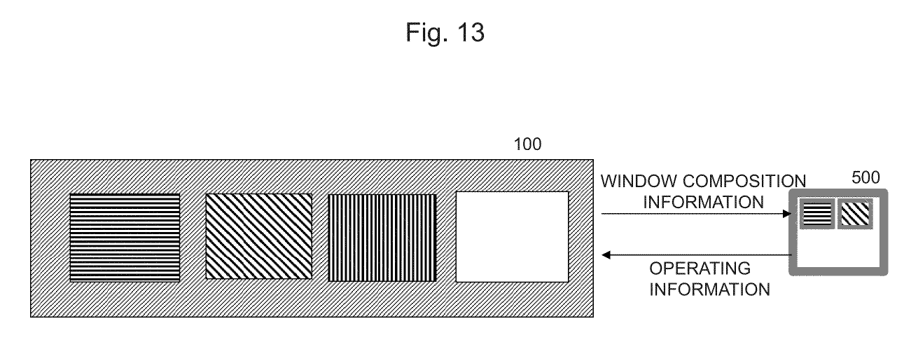

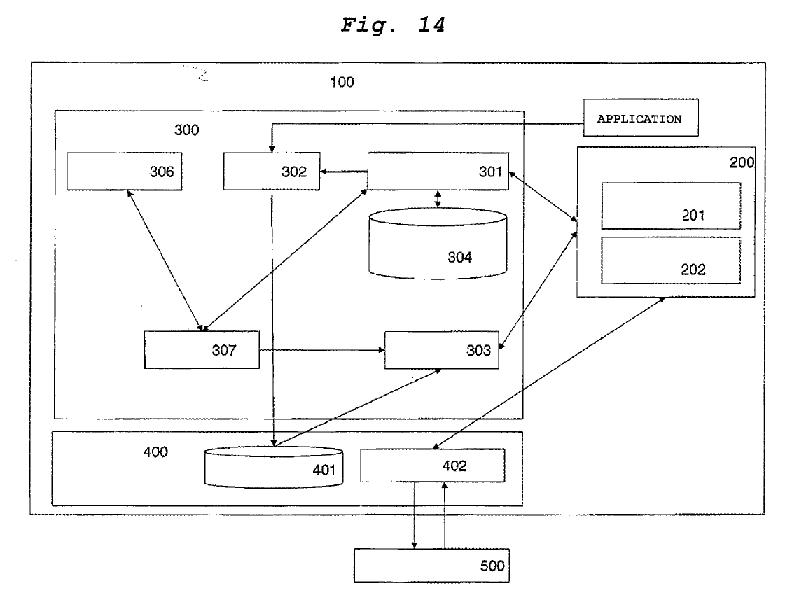

An example of a displayed screen at the layout control device 500 according to the fourth embodiment is shown in FIG. 13. FIG. 13 shows an example that displays just the left half of the screen of the large screen display device 100 on the layout control device 500. In this case, the generation section 201 generates only the window composition information that corresponds to the two windows that are displayed in the left half of the screen.

For changes in the window composition information of the windows that are not displayed on the layout control device 500, it is possible to, for example, not transmit such composition information at all, or it can be transmitted at an arbitrary time, such as when there are few changes to the window composition information for windows that are displayed on the layout control device 500.

In this way, the large screen display device according to the fourth embodiment can alleviate load by sending only the window composition information for windows that are displayed on the layout control device 500.

### Fifth Embodiment

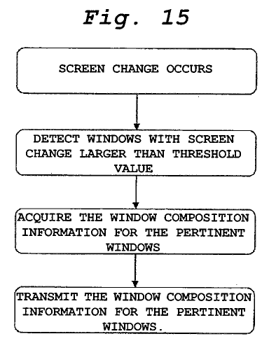

In the first embodiment, only the window image of the window that included the areas that were newly displayed on the screen was transmitted. In the fifth embodiment, an example that transmits the window image for a window with a large image change is described. A block diagram of the large screen display device 100 according to the fifth embodiment is shown in FIG. 14.

The fifth embodiment differs from the first embodiment in inclusion of an application, an update detection section 306, a determination section 307. The functioning of the layout management section 301, the drawing section 302, and the image acquisition section 303 also differs somewhat from the first embodiment. The other components are generally the same as in the large screen display device 100 according to the first embodiment, so their descriptions are omitted here. The sections that are common to the first embodiment have the same legend numbers.

The application is a program that provides various processes that operate on the large screen display device 100. The application issues drawing commands to the drawing section 302 for displaying on the screen.

The drawing section 302 receives drawing instructions from the application and issuing section 202 and draws in the frame buffer 401. Drawing section 302 also stores the updated area that is specified by the coordinate information included in the drawing instructions to the update detection section 306.

The method of storage used by drawing section 302 can include anything that can specify the updated areas of the screen. For example, the drawing section 302 can store the updated areas as a list of rectangle information, such as a rectangular area that is 10 pixels wide and 10 pixels tall from (0, 0) and a rectangular area that is 200 pixels wide and 5 pixels tall from (30, 30).

The update detection section 306 notifies the determination section 307 as to the updated areas.

The update detection section 306 can include difference extraction processes. Difference extraction processes will compare the screen information in frame buffer 401 corresponding to the updated area and the backup screen (the screen information previously sent to the layout control device 500) and extract the difference area (the area where there actually is a change), and use only that difference area as the updated area. Also, update detection section 306 updates the backup screen of the area that corresponds to the difference area.

The determination section 307 determines the area that intersects with the updated window area using the updated window area and the layout information. If the area is determined to be larger than some threshold value s, the determination section 307 will determine that the window composition information that corresponds to the pertinent window requires updating and will notify the layout management section 301 and the image acquisition section 303 of the pertinent window. Further, an area corresponding to a window that is notified to be updated is detected from the updated area of the update detection section. Also, the determination section 307 can start the determination process each time drawing occurs or by periodic triggers from a timer.

The layout management section 301, when it receives a notice from the determination section 307, will send the layout information to the generation section 201.

The image acquisition section 303, when it receives a notice from the determination section 307, will send the window image to the generation section 201.

Next, an overview of the window composition information transmission process will be provided using FIG. 15. First, application (for the screen display) or issuing section 202 (for changing the screen layout) will issue a drawing instruction, and the drawing section 302 will draw in the frame buffer 401 and update the update area.

Next, with a periodic trigger from the timer, for example, a determination process is started. The determination section 307, based on the window area that is calculated from the update area that it receives from the update detection section 306 and from the layout information that it receives from the layout management section 301, will determine the window or windows where the overlap area of the update area is larger than the threshold value s. The determination section 307 will notify the layout management section 301 and the image acquisition section 303 of the pertinent window or windows.

Next, the layout management section 301 and the image acquisition section 303 will hand over the layout information and the window image of the notified window(s) to the generation section 201.

Next, the generation section 201 will generate the window composition information, and the communications section 402 will transmit the window composition information.

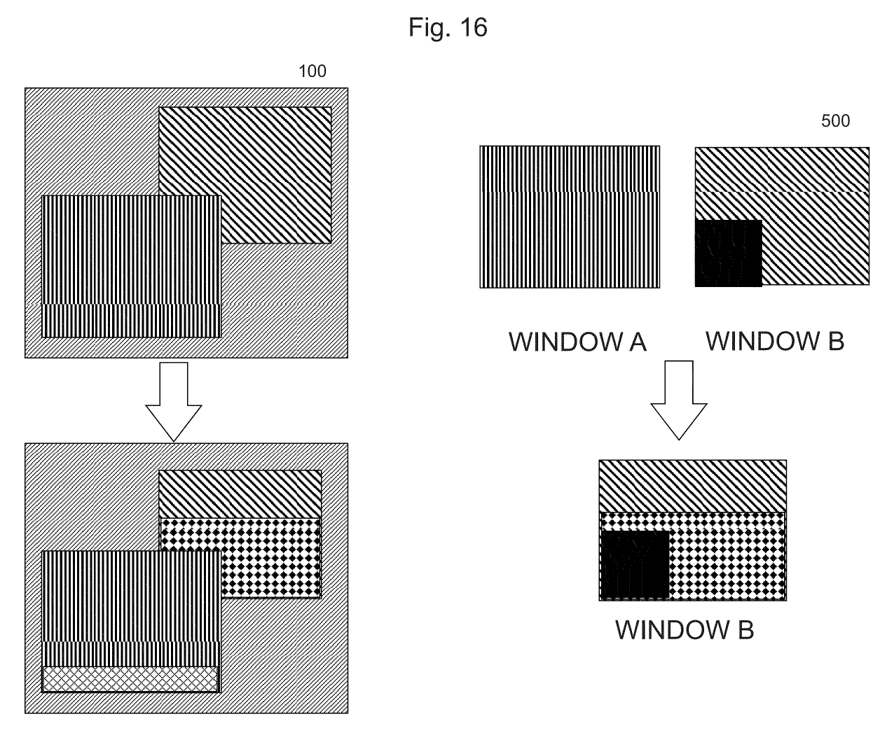

An example of the window image that may be determined as requiring updating is shown in FIG. 16. For example, when the threshold value s is defined as being half the window size, the window image of window A (for which the change in the image is less than half the window size) will not be transmitted, and the window image of window B (for which the change in the image is more than half the window size) will be transmitted. That is, the window image of window A with a small change will not be updated, and the window image of window B with a large change will be updated.

The threshold value can be dynamically altered according to the load on the large screen display device 100 and/or the layout control device 500. Also, the threshold value can be changed for each window according to the level of importance assigned to the window.

In this way, the large screen display device 100 according to the fifth embodiment can manage loads while maintaining the discernibility of the windows by sending only window images of windows with large changes in the image.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

What is claimed is:

1. A screen display device having specific display areas controlled by operating a layout control terminal that is connected thereto, the device comprising:
a window composition information generation section configured to generate a screen composition information for specific display areas that are being controlled by the operation of the layout control terminal;
a layout management section configured to manage the screen composition information for the specific display areas; and
a communications section configured to transmit the screen composition information for the specific display areas to the layout control terminal.

2. The screen display device according to claim 1, further comprising:
a layout change detection section configured to detect changes in the specific display areas;
wherein the window composition information generation section is configured to generate the screen composition information for a specific display area when changes in the specific display area are detected.

3. The screen display device according to claim 1, further comprising:
a load acquisition section configured to acquire a load of the layout control terminal;
wherein the window composition information generation section is configured to generate the screen composition information of the specified areas according to the load.

4. The screen display device according to claim 3, wherein the screen composition information of the specified areas includes a window name.

5. The screen display device according to claim 3, wherein the window composition information generation section is configured to generate the screen composition information to be of different types when the load of the layout control terminal is higher than a specified threshold value than when the load of the layout control terminal is lower than the specified threshold value.

6. The screen display device according to claim 5, wherein a plurality of threshold values are set up, one of the threshold values being the specified threshold value.

7. The screen display device according to claim 1, further comprising:
a display area acquisition section configured to acquire a display area to be displayed by the layout control terminal;
wherein the window composition information generation section is configured to generate the screen composition information of the specific display area that corresponds to the display area to be displayed by the layout control terminal with a higher priority than other specific display areas.

8. The screen display device according to claim 7, further comprising:
an update detection section configured to detect updates in the specific display areas,
wherein the window composition information generation section is configured to generate a screen composition information of the specific display areas in accordance with the updates detected by the update detection section.

9. The screen display device according to claim 8, wherein the update detection section is configured to detect the updates by a difference extraction process.

10. A screen display system comprising:
a layout control terminal; and
a screen display device connected to the layout control terminal via a network, the screen display device including:
a window composition information generation section configured to generate a screen composition information for specific display areas that are being controlled by the operation of the layout control terminal;
a layout management section configured to manage the screen composition information for the specific display areas; and
a communications section configured to transmit the screen composition information for the specific display areas to the layout control terminal.

11. The screen display system of claim 10, further comprising a plurality of layout control terminals each controlling one or more of the specific display areas.

12. The screen display system of claim 10, further comprising:
a drawing section configured to receive a first drawing instruction from the layout management section and to draw a screen displayed on the screen display device accordingly;
a frame buffer configured to store screen data.

13. The screen display system of claim 12, wherein the drawing section is configured to receive a second drawing instruction from an application and to draw the screen accordingly, and differences in the screen data of the screen drawn according to the first drawing instruction and the screen data of the screen drawn according to the first drawing instruction are transmitted to the layout control terminal.

14. The screen display system according to claim 10, further comprising:
a layout change detection section configured to detect changes in the specific display areas;
wherein the window composition information generation section is configured to generate the screen composition information for a specific display area when changes in the specific display area are detected.

15. The screen display system according to claim 14, wherein the window composition information generation section is configured to compress the screen composition information when the load is high.

16. The screen display system of claim 10, further comprising:
a display area acquisition section configured to acquire a display area to be displayed by the layout control terminal;
wherein the window composition information generation section is configured to generate the screen composition information of the specific display area that corresponds to the display area to be displayed by the layout control terminal with a higher priority than other specific display areas.

17. The screen display system according to claim 10, further comprising:
an update detection section configured to detect updates in the specific display areas,
wherein the window composition information generation section is configured to generate a screen composition information of the specific display areas in accordance with the updates detected by the update detection section.

18. A screen display system, the system comprising:
a display screen configured to display an image window;
a window server configured to manage layout information of the display screen and draw the window image to be displayed on the display screen according to an operating instruction;
a web server program configured to issue the operating instruction and to provide a window composition information for the image window to be displayed on the display screen; and
a layout control device configured to manipulate the image window to be displayed on the display screen by transmitting the operation instruction to the web server program,
wherein the image window is sent to the display screen for display when the image window is updated and is not sent to the display screen for display when the image window is not updated.

19. The screen display system of claim 18, further comprising a layout change detection section configured to determine when a hidden part of the image window is displayed and to trigger an image window update when the hidden part of the image window is displayed.

20. The screen display system of claim 18, further comprising a load acquisition section configured to determine when a processing or communication load of the display system is above a predetermined level and to adjust the image window to be displayed on the display screen if the processing or communication load of the display system is above the predetermined level.
